(19) United States
(12) Patent Application Publication
(10) Pub. No.: US 2004/0045448 A1
(43) Pub. Date: Mar. 11, 2004

(54) Fryer

(76) Inventors: Takehiko Abe, Kanagawa (JP); Eiichi Ishizeki, Kanagawa (JP)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/416,258

(22) PCT Filed: Nov. 8, 2001
(86) PCT No.: PCT/JP01/09777

(30) Foreign Application Priority Data
Nov. 8, 2000 (JP) 2000-340301

(51) Int. Cl. A23L 1/00; A47J 37/12

(52) U.S. Cl. 99/403

(57) ABSTRACT

An electrode unit 25 applied with a high voltage and a grounded earth plate 26 are disposed in an oil bath 21 in a mutually opposed relationship, and an electric field shielding layer 22 made of insulation material is disposed so as to surround a frying region between the electrode unit and the earth plate 26, with the electrode unit 25 being applied with the high voltage to create a high-voltage weak current in the frying region. For this reason, a safety of a user can be enhanced, permitting the high-voltage weak current to afford a preferable influence to food material.

### TECHNICAL FIELD

The present invention relates to a frier for frying fry food material by oil and, more particularly, to a batch type frier equipped with an electric field forming means in an oil bath.

### BACKGROUND ART

As a frier of this kind, a frier has been in general use wherein an oil bath is externally heated to heat cooking oil in the oil bath for thereby permitting tempura and fry product to be cooked. When using such a general frier, oil in the oil bath tends to be subjected to heat and oxidized and deteriorated, resulting in an issue of color change being easily encountered. Also, as a result of this oxidation of oil, an issue arises in that fried food product is apt to progressively deteriorate and rot. Concrete issues resulting from such a frier when cooking fried food material concerns the following points.

(A) Fried food material absorbs oil component too much, resulting in a difficulty in obtaining a crisply fried product.

(B) Moisture and nutrient component tend to dissolve from the fried food material into oil to cause taste to escape and fried product becomes small in size to cause a reduction in a yield.

(C) Build up frying oil temperature increases.

(D) Frying time is extended.

(E) Improvement in an anti-virus property of fried product is to be achieved.

(F) Improvement in an anti-spoiling property is to be achieved.

A measure to solve such issues is proposed to provide a frier 1 as disclosed in Japanese Patent Publication No. 10-276744. As shown in FIG. 1, the frier 1 has a frying oil bath 2 in which a plurality of heater pipes 3 are spanned in mutually parallel relationship. Disposed above the heater pipes 3 in the frying oil bath 2 is an insulation frame 4 made from ceramic material formed in a flat rectangular shape. Disposed in the insulation frame 4 is a conducting plate 5 that is formed with a large number of circular bores. Also, an upper surface of the conducting plate 5 is covered with an insulation plate 6 made from fluorine resin and formed with a large number of bores. The conducting plate 5 is connected to a relay unit 8, an intermediate control unit 9 and a high-voltage weak current generator 10 in sequence through a wire harness 7.

Such a frier 1 is arranged to allow a high-voltage weak current to flow from the conducting plate 5 to frying oil 11. As a result of action of this high-voltage weak current, frying oil is prevented from being oxidized for thereby addressing the above-described issues.

However, in the frier 1 set forth above, since the electric field in which high-voltage weak current occurs is limited to a peripheral area of the conducting plate 5, frying oil remaining in a position displaced from such an electric field was not exposed to the electric field caused by the high-voltage weak current and, hence, a difficulty was encountered in restricting oxidizing action.

Further, in a case where fry food material is fried at a position displaced from the periphery of the conducting plate 5, fry food material was not influenced by action of the electric field and it was hard to solve the above-described issues.

Also, even though it is conceivable that a range in which the electric field is influenced can be expanded by providing the oil bath 2 formed from a conductive body and locating the oil bath 2 in opposed relationship with the conducting plate 5 for thereby permitting the oil bath 2 per se to serve as an opposing electrode, conducting the oil bath 2 even at a weak current causes an unfavorable situation in view of a security for a user.

Furthermore, even though an upper surface of the conducting plate 5 is covered with the insulation plate 6, since there are regions which are exposed at a lower surface and inside bores of the insulation plate 6, moisture dissolving from fry food material and oxidized polymerization product resulting from high oil temperature adhered to the conducting plate 5, causing probabilities of weak leakage current and imperfect operation of a transformer to occur in a short time period.

Also, the frier 1 set forth above had a weak action to cause the high-voltage electric field energy to inductively penetrate through fry food material forming an objective to be influenced with the electric field occurring in the conducting plate 5.

### DISCLOSURE OF INVENTION

The present invention has been completed to address the above-described issues.

To this end, it is an object of the present invention to provide a frier which has a safety for a user and an improved utilizing efficiency of a high-voltage weak current.

Further, it is another object of the present invention to provide a frier which is able to utilize thermal transfer for thereby achieving shortening of a frying time, lowering of a frying oil temperature and reduction in the amount of oil component to be absorbed in fry food material.

Furthermore, it is another object of the present invention to provide a frier which is able to promote irreversible destroy of a cell wall of a bacterium occurring in frying oil to improve an anti-virus property and an anti-spoiling property of fry food material.

Moreover, it is another object of the present invention to provide a frier which is able to restrict occurrence of an oxidized polymerization product resulting from deterioration accompanied by moisture dissolving from fry food material and a heated high temperature of frying oil in a frying step for thereby decreasing the amount of waste oil to reduce the amount of harmful product, to be ingested together with fry food material, which is ingested by a human body.

Also, it is another object of the present invention to provide a frier which is able to allow fry food material to be crisply fried while restricting fry food material from absorbing a large amount of oil component.

Further, it is another object of the present invention to provide a frier which restricts moisture and nutrient component from dissolving into oil from fried fry food material for thereby improving a yield of fried product.

Furthermore, it is another object of the present invention to provide a frier which is able to lower a frying temperature to build up.

A first aspect of the present invention provides a frier comprising an electrode unit applied with a high voltage and a grounded earth plate are disposed in an oil bath in mutually opposed relationship, and an electric field shielding layer composed of insulation material is disposed so as to surround a frying region between the electrode unit and the earth plate whereupon the electrode unit is applied with the high voltage to cause a high-voltage weak current to occur in the frying region.

A second aspect of the present invention concerns, in addition to the first aspect of the frier of the present invention, a frier wherein the electric field shielding layer is formed over and adheres to an entire inner side wall of the oil bath.

A third aspect of the present invention concerns, in addition to the first aspect of the frier of the present invention, a frier wherein a heater pipe is disposed in a bottom area of the oil bath such that the electrode unit is located above the heater pipe and the earth plate is located above the electrode unit.

A fourth aspect of the present invention concerns, in addition to the first aspect of the frier of the present invention, a frier wherein a heater pipe is disposed in a bottom area of the oil bath such that the earth plate is located above the heater pipe and the electrode unit is located above the earth plate.

A fifth aspect of the present invention concerns, in addition to the first aspect of the frier of the present invention, a frier wherein the electrode unit is formed by an electrode plate, made from conductive metal, which has an entire surface area covered with insulation material.

A sixth aspect of the present invention concerns, in addition to the first aspect of the frier of the present invention, a frier wherein the electrode unit is formed with an opening portion to allow convection of frying oil in the oil bath.

A seventh aspect of the present invention concerns, in addition to the first aspect of the frier of the present invention, a frier wherein the earth plate is formed by a frame body, made of conductive material, in which a plurality of chains, composed of conductive material, are spanned.

An eighth aspect of the present invention concerns, in addition to the first aspect of the frier of the present invention, a frier wherein the earth plate includes a net-like body composed of conductive material.

A ninth aspect of the present invention concerns, in addition to the first aspect of the frier of the present invention, a frier wherein the electrode unit and the earth plate are relatively moveable.

### BRIEF DESCRIPTION OF DRAWINGS

FIG. 1 is a cross sectional illustrative view showing a frier of the related art.

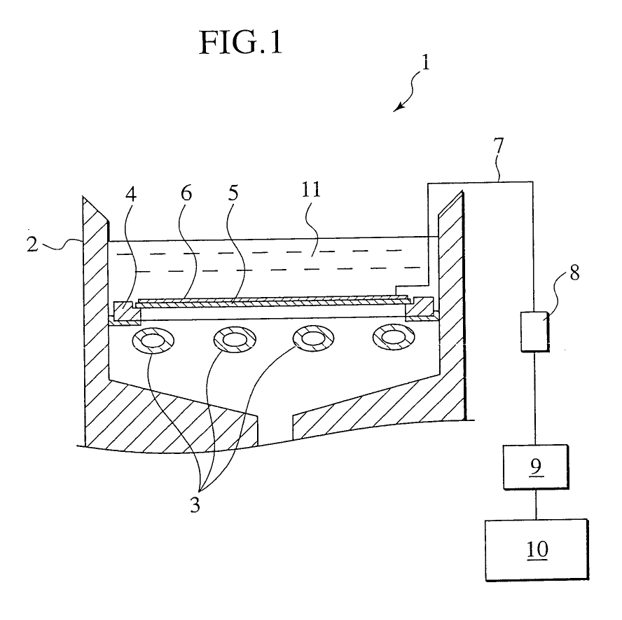

FIG. 2 is a cross sectional view of a first embodiment of a frier according to the present invention and shows a cross sectional condition as viewed from a side.

FIG. 3 is a cross sectional view of the first embodiment of the frier according to the present invention and shows a cross sectional condition as viewed from a front side.

FIG. 4 is a perspective view of an earth plate for use in the frier of the first embodiment.

FIG. 5 is a plan view of the frier of the first embodiment.

FIG. 6 is a plan view of the frier of the first embodiment.

FIG. 7 is a cross sectional view of a second embodiment of a frier according to the present invention and shows a cross sectional condition as viewed from a side.

FIG. 8 is a cross sectional view of the second embodiment of the frier according to the present invention and shows a cross sectional condition as viewed from a front side.

FIG. 9 is a plan view of the frier of the second embodiment.

FIG. 10 is a plan view of the frier of the second embodiment.

FIG. 11 is a cross sectional view of a third embodiment of a frier according to the present invention and shows a cross sectional condition as viewed from a front side.

FIG. 12 is a cross sectional view of the third embodiment of the frier according to the present invention and shows a cross sectional condition as viewed from a side.

### BEST MODE FOR CARRYING OUT THE INVENTION

A detail of a frier according to the present invention is described hereinafter with reference to embodiments shown in the drawings. However, the drawings are of typical natures, and dimensions and shapes of respective component parts differ from those of actual configurations.

(First Embodiment)

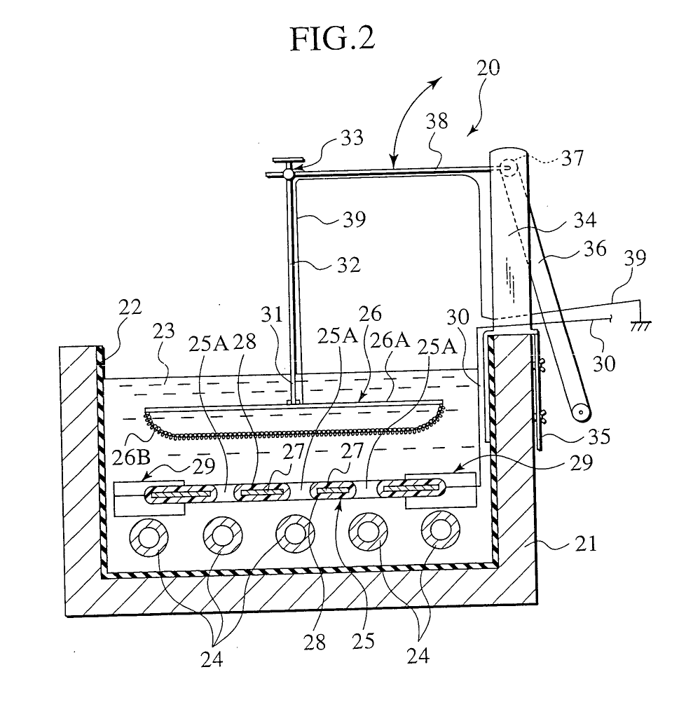

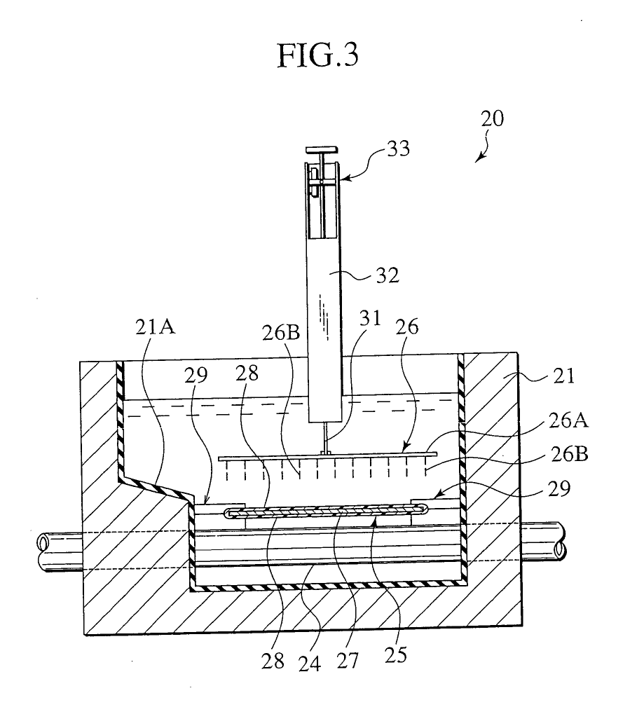

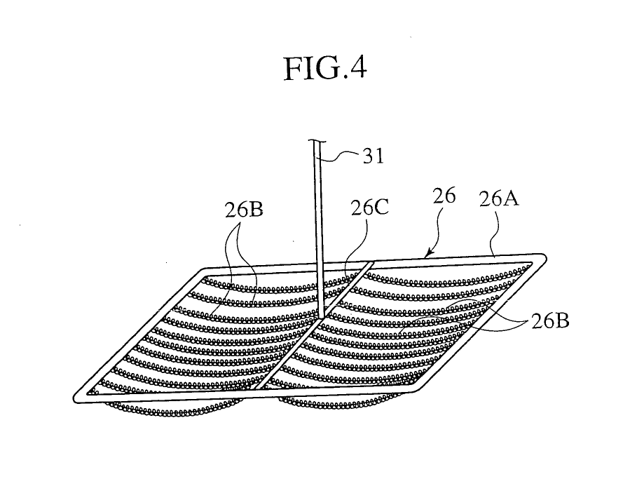

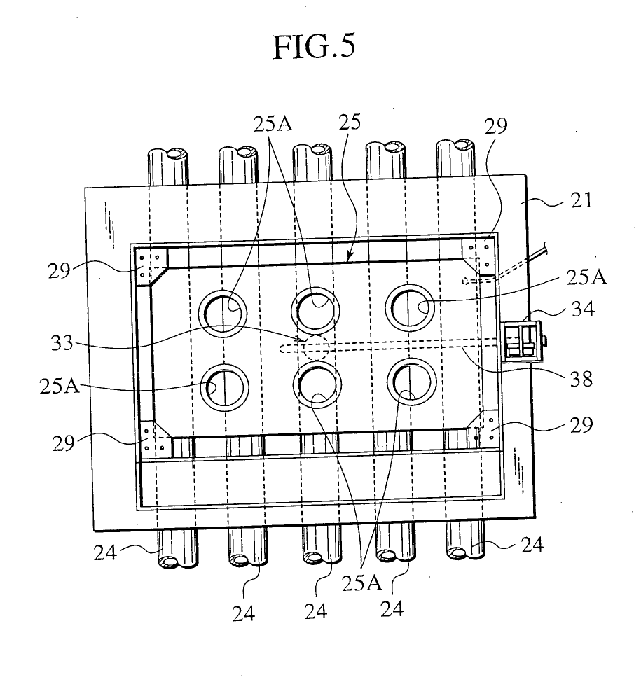

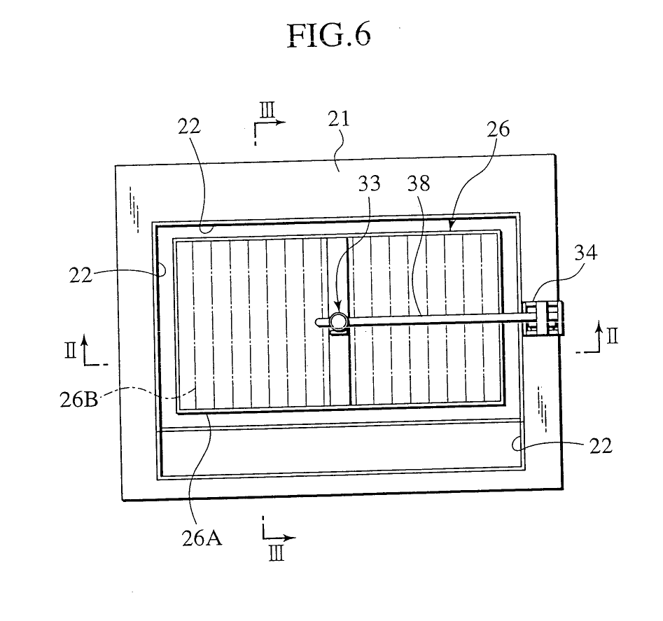

FIGS. 2 to 6 show a first embodiment of a frier according to the present invention. The first embodiment is an example of a frier of a batch type to which the present invention is applied. FIG. 2 is a cross sectional view (taken on line II-II of FIG. 6) of the frier 20 as viewed from a side thereof, FIG. 3 is a cross sectional view (taken on line III-III of FIG. 6) of the frier as viewed from a front thereof, FIG. 4 is a perspective view of an earth plate 26, FIG. 5 is a plan view showing a condition where an electrode plate 25 is disposed in an oil bath 21, and FIG. 6 is a plan view of the frier 20.

As shown in FIGS. 2 and 3, the frier 20 according to the first embodiment is roughly comprised of an oil bath 21, an electric-field shielding layer 22 formed over an entire area of an inner side of the oil bath 21 to cover the same, a plurality of heater pipes 24 that heat frying oil 23 contained in the oil bath 21, an electrode unit 25 disposed directly above the heater pipes 24, and an earth plate 26 disposed for upward or downward moving capability with respect to the electrode unit 25.

As shown in FIG. 3, the oil bath 21 has one side formed with a step portion 21A that is inclined toward a bottom side and has a function to guide food materials onto the electrode unit 25. In the first embodiment, the oil bath 21 is made from materials such as stainless steel, aluminum and other various metallic materials. Also, the oil bath 21 is made from other materials than the metallic materials, such as heat resistant plastic resin and ceramic material of high strength.

The electric-field shielding layer 22 is composed of fluorine resin having a heat-resistant property and a water-repellent property. And, the electric-field shielding layer 22 is formed over the entire inner surface of the oil bath 21 so as to bond to the inner surface of the oil bath 21 by vacuum finishing. The electric-field shielding layer 22 has a function to shield an electric field formed between the electrode unit 25 and the earth plate 26 and has an action to increase a strength of the electric field formed between the electrode plate 25 and the earth plate 26.

As shown in FIGS. 2 and 3, the heater pipes 24-24 are located so as to extend in a horizontal direction along a bottom surface of the oil bath 21 in parallel with respect to one another. Also, while the first embodiment is an example where the respective heater pipes 24 extend through a low area of the oil bath 21, of course, a single piece of pipe 24 may be bent in a zigzag form within the oil bath 21. In the frier according to the present invention, the heater pipe 24 may take various forms.

Referring now to FIGS. 2, 3 and 5, a structure of the electrode unit 25 is described. As shown in FIG. 2, the electrode unit 25 is comprised of an electrode plate 27 made from, for instance, conductive metal composed of stainless steel in a substantially rectangular shape, and an insulation covering 28 that is entirely covered on the surface of the electrode plate and composed of, for example, fluorine resin. While, in FIG. 2, the insulating covering 28 has been shown in a single layer, in an actual practice, the insulation covering is structured such that an insulating vapor deposition film composed of, for example, fluorine resin is coated over an entire surface of a conductive metallic plate and, further, an insulation sheet composed of fluorine resin is adhered (wrapped) under pressure to an outside area of the insulating vapor deposition film under an evacuated condition.

Also, as examples of the vapor deposition film and the insulation sheet, it is possible to use, for instance, insulation material formed by Teflon work. Of course, the present invention is not limited to the Teflon work provided that insulation is enhanced.

As shown in FIG. 5, the electrode plate 27 is formed with a plurality of opening portions 25A. Also, formed on an inside wall of each opening portion 25A is an insulation covering 28. For this reason, it becomes possible for frying oil to convect through the opening portions 25A to allow frying oil temperature to be uniformed. Also, the electrode unit 25 is formed in a substantially rectangular shape that is slightly smaller in area than the bottom wall of the oil bath 21.

And, four corners of the electrode unit 25 are supported by support members 29 fixedly secured to the interior of the oil bath 21 at a lower area thereof. And, connected to a peripheral edge portion of the electrode plate 27 at a given position thereof is a wire harness 30 that is covered with heat-resistant insulation material. The wire harness 30 is connected to a voltage control device, not shown, that outputs a high voltage at a given level. Also, the voltage control device has a primary winding to which an alternating voltage at a commercial frequency is applied and a secondary winding that is energized with a high-voltage weak current obtained from a transformer having a secondary winding with one pole being sealed off.

As shown in FIG. 4, the earth plate 26 has a structure wherein chains 26B each made from conductive material are spanned on an earth frame 26A made from conductive material in a rectangular shape, and a lower end of an elevating rod 31 is fixed to a centrally extending frame portion 25c. An upper end of the elevating rod 31 is connected to a lower end of an elevating plate 32. Further, an elevating adjustment gear member 33 is located on an upper portion of the elevating plate 32. Furthermore, a strut 34 stands upright at an upper area of one side wall of the oil bath 21. Also, a lower portion of the strut 34 is fixedly secured to the one side wall of the oil bath 21 by means of a holder portion 35. Rotationally supported on an upper portion of the strut 34 is a gear 37 that is drivingly rotated by an endless chain 36.

Further, supported on the upper portion of the strut 34 is a hanging rod 38 that is coaxially rotated on an axis of the gear 37 due to rotational operating section which is not shown. A distal end of the hanging rod 38 is supported by the elevating adjustment gear member 33. And, the elevating adjustment gear member 33 is drivingly raised and lowered with respect to the hanging rod 38. Also, this elevating drive mechanism includes a known rotation transfer mechanism or a gear mechanism and, description of such structure is herein omitted. Further, connected to the earth plate 26 is an grounding wire 39 that is covered with heat-resistant insulation resin. This grounding wire 39 is disposed along the elevating rod 31, the elevating plate 32, the hanging rod 38 and the strut 34 and connected to ground.

With the frier 20 of such a structure, fry food material is placed below the earth plate 26. When this takes place, fry food material is arranged to be brought into contact with the chains 26B due to its buoyancy. As the electrode unit 25 is applied with the high-voltage weak current from the high voltage control device, a high voltage with weak electric field occurs in a fry area between the electrode unit 25 and the earth plate 26. This electric field is surrounded by the electric field shielding layer 22 and, hence, no leakage of electric field to the outside occurs, resulting in an increased strength of the electric field between the electrode unit 25 and the earth plate 26. That is, the electric field created from the electrode unit 25 toward the earth plate 26 is prevented from leaking to the oil bath 21 with no occurrence of disturbance in the electric field in the fry area. For this reason, the fry food material is reliably subjected to the influence of the high-voltage weak current to decrease an oil absorption rate and no escape of taste due to elution of moisture and nutrient component from fry food material into flying oil occurs, while enabling fry food material from being decreased in size. This allows food material to be fried so as to have a sense of touch in crisply fried food with taste trapped therein, while making it possible to improve a yield of fry food material.

Further, in the first embodiment, by energizing frying oil with the high-voltage weak current, it is possible to decrease a frying oil temperature to fry up at a lower temperature than that of a normal practice. More particularly, frying carried out at the frying oil temperature of normally 180° C. can be performed at a temperature of approximately 120° C. Thus, frying time can be shortened even in the presence of the lowered frying oil temperature.

Further, in the first embodiment, due to flow of the high-voltage weak current through frying oil, since cell walls of germs such as bacteria contained in frying oil can be irreversibly destroyed, fried pieces have improved anti-virus properties. This enables fried pieces to have improved anti-spoiling properties.

(Second Embodiment)

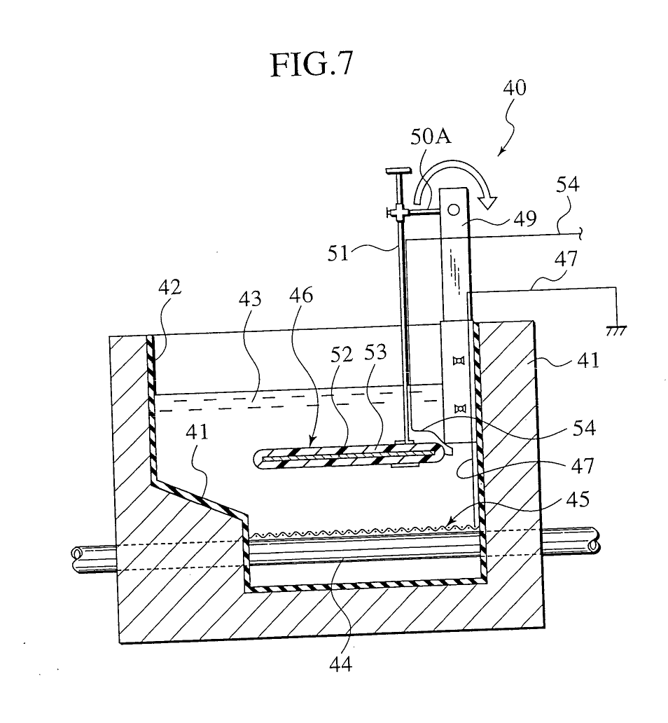

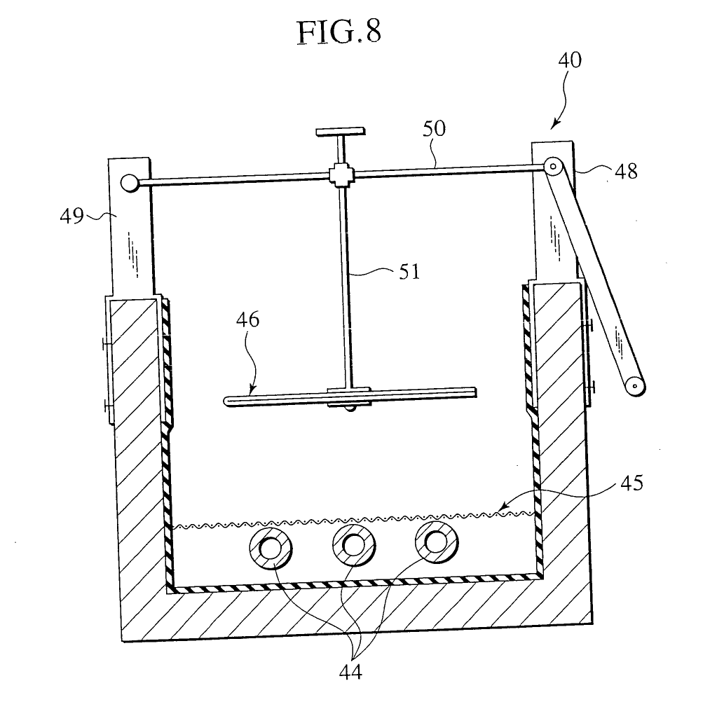

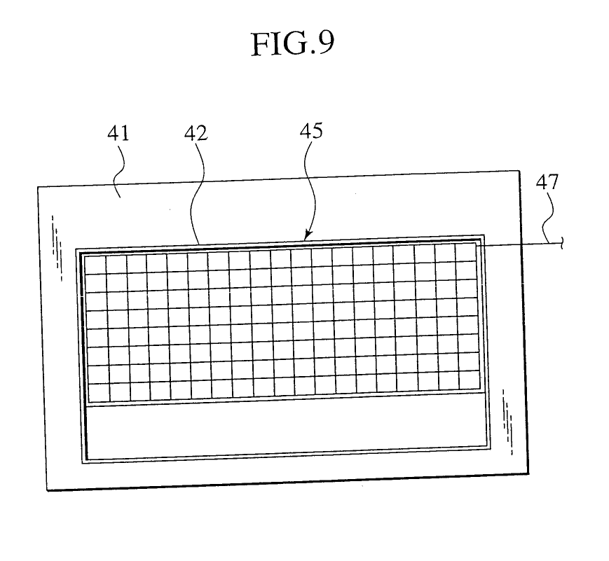

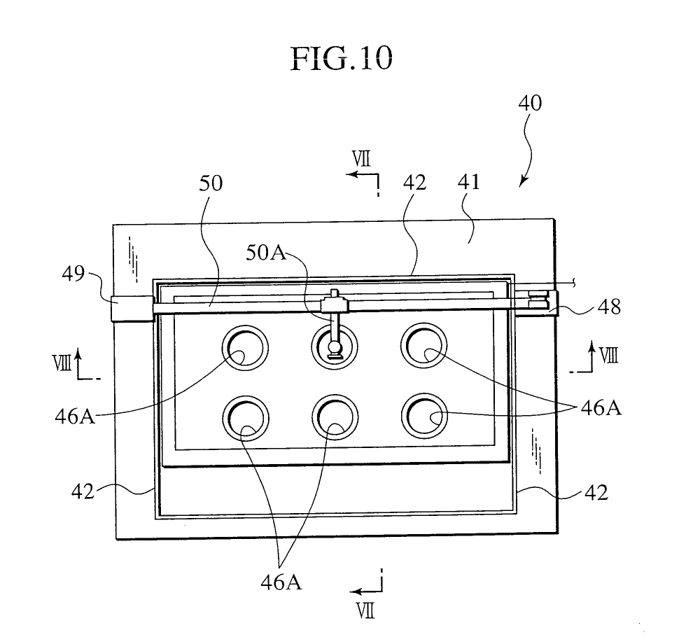

FIGS. 7 to 10 show a second embodiment of a frier according to the present invention. The frier of the second embodiment takes a batch form. FIG. 7 is a cross sectional view (taken on line XII-XII in FIG. 10) of a frier 40 as viewed from a side wall, FIG. 8 is a cross sectional view (taken on line XIII-XIII in FIG. 10) as viewed from a front side, FIG. 9 is a plan view illustrating a situation wherein an earth plate id disposed, and FIG. 10 is a plan view illustrating a situation in which an electrode plate is located in an oil bath.

As shown in FIGS. 7 and 8, the frier 40 of the second embodiment is roughly comprised of an oil bath 41, an electric-field shielding layer 42 formed over an entire area of an inner side of the oil bath 41 to cover the same, a plurality of hater pipes 44 that heat frying oil 43 contained in the oil bath 41, an earth plate 45 disposed directly above the heater pipes 44, and an electrode unit 46 disposed in an upper area of the earth plate 45 in opposed relationship thereto for raising and lowering movements.

As shown in FIG. 7, the oil bath 41 has one side formed with a step portion 41A that is inclined toward a bottom side to have a function to guide food materials onto a space between the earth plate 45 and the electrode unit 46. In the second embodiment, also, the oil bath 41 is made from materials such as stainless steel, aluminum and other various metallic materials.

The electric-field shielding layer 42 is composed of fluorine resin having a heat-resistant property and a water-repellent property. And, the electric-field shielding layer 42 is formed over the entire inner surface of the oil bath 41 so as to bond to the inner surface of the oil bath 41 by a vacuum finishing. The electric-field shielding layer 42 has a function to shield an electric field formed between the electrode unit 46 and the earth plate 45 and has an action to increase a strength of the electric field formed between the electrode unit 46 and the earth plate 45.

As shown in FIG. 7, the heater pipes 44-44 are located so as to extend in a horizontal direction along a bottom surface of the oil bath 41 in parallel with respect to one another. The second embodiment is also configured such that the respective heater pipes 44 extend through a low area of the oil bath 41.

As shown in FIG. 9, the earth plate 45 is made of a net-like plate composed of conductive metal. And, as shown in FIG. 7, a grounding wire 47 is connected to a peripheral edge of the earth plate 45 at a given position thereof and covered with heat-resistant insulation covering. This grounding wire 47 is extended outward the oil bath 41 and grounded.

As shown in FIG. 8, the electrode unit 46 is connected to a lower end of an elevating rod 51 suspended from an arm rod 50A centrally protruding from a hanging rod 50 spanned between struts 48, 49 standing upright at both side walls of the oil bath 41. Even in the second embodiment, the elevating rod 51 is disposed for raising and lowering movements. As shown in FIG. 10,. the electrode unit 46 is comprised of an electrode plate 52 made from conductive metal substantially configured in a rectangular shape and formed with a plurality of opening portions, and an insulation covering 53 composed of, for example, fluorine resin covered over an entire surface of the electrode plate 52. As a result of the insulation coverings 53 being formed at inner side walls of the plurality of opening portions of the electrode plate 52, the electrode unit 46 is formed with a plurality of opening portions 46A as shown in FIG. 10.

And, connected to the electrode plate 46 at a given position thereof is a wire harness 54 that is covered with heat resistant insulation material. The wire harness 54 is extended outward along the elevating rod 51, the arm rod 50A and the hanging rod 50. Also, the wire harness 54 is connected to a voltage control device, which is not shown, that outputs a high voltage at a given voltage. Moreover, the voltage control device of the second embodiment has the same structure as that of the first embodiment set forth above and has a primary winding to which an alternating voltage at a commercial frequency is applied and a secondary winding that is energized with a high-voltage weak current obtained from a transformer having a secondary winding with one pole being sealed off.

Even in the second embodiment, in a case where fry food material settles with respect to frying oil, fry food material can be reliably brought into contact with the earth plate 45. Thus, when the electrode unit 46 is applied with the high-voltage weak current from the voltage control device, a high voltage weak electric field is created in a fry area between the electrode unit 46 and the earth plate 45. This electric field is surrounded by the electric field shielding layer 42 and, hence, there is no leakage of electric field to be externally formed for thereby providing an action to increase the strength of the electric field between the electrode unit 46 and the earth plate 45. For this reason, the fry food material is reliably subjected to the influence of the high-voltage weak current to decrease an oil absorption rate and no escape of taste due to elution of moisture and nutrient component from fry food material into flying oil occurs, while enabling fry food material from being decreased in size. For this reason, a yield of fry food material can be improved.

Further, even in the second embodiment, by energizing frying oil with the high-voltage weak current, it is possible to decrease a frying oil temperature to fry up at a lower temperature than that of a normal practice. This allows food material to be fried so as to have a sense of touch in crisply fried food with taste trapped therein, while making it possible for oxidation of frying oil to be limited.

Further, in the second embodiment, due to flow of the high-voltage weak current through food material to be fried, frying time can be shortened.

Further, in the second embodiment, due to flow of the high-voltage weak current through frying oil, since cell walls of germs such as bacteria contained in frying oil can be irreversibly destroyed, fried pieces have improved anti-virus properties. This enables fried pieces to have improved anti-spoiling properties.

(Third Embodiment)

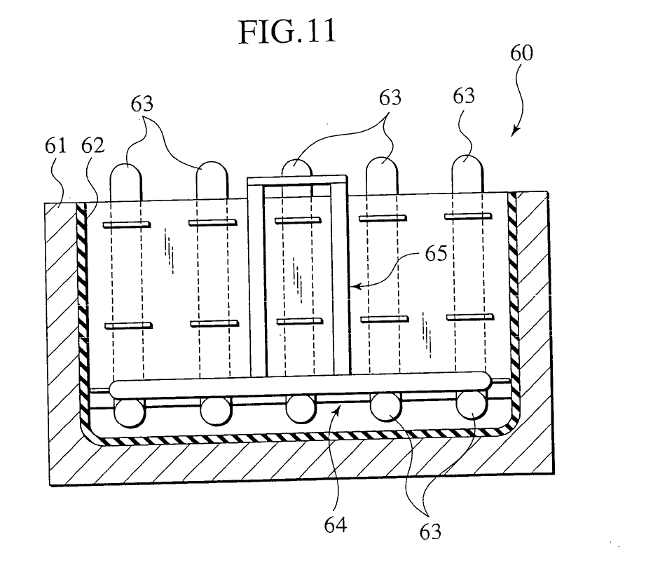

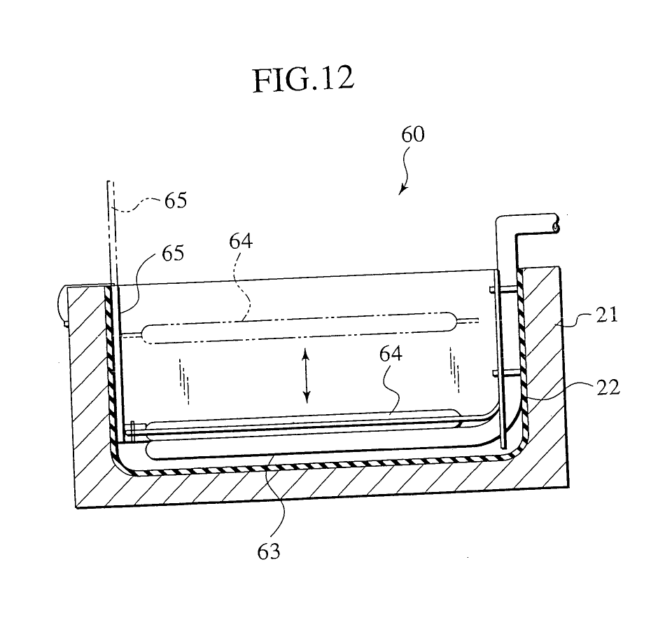

FIGS. 11 and 12 show a third embodiment of a frier according to the present invention. In the frier 60 of the third embodiment, an electric field shielding layer 62 is formed over an entire inner side wall of an oil bath 61. Also, a heater pipe 63 located in the oil bath 61 is arranged in a configuration wherein the heater pipe is introduced in the oil bath 61 from one side of side walls and bent in a zigzag shape at a bottom area of the oil bath 61 such that it extends from the other side of the side walls to the outside of the oil bath 61. For this reason, in the third embodiment, there is no need for the heater pipe 63 to penetrate the oil bath 61.

Further, in the third embodiment, the electrode unit 64 is driven together with an elevating frame 65 for raising and lowering movements for free elevating movement. Also, the earth plate, which is not shown, of the frier 60 of the third embodiment may be disposed beneath the electrode unit 64 or may be configured to be located above the electrode unit 64.

In the third embodiment, since the heater pipe 63 does not penetrate the oil bath 61, there is no need for providing oil leakage structure in the oil bath 61 and, also, raising the electrode unit 64 together with the elevating frame 65 allows the electrode unit 64 to be removed from the oil bath 61. Thus, the third embodiment makes it possible to provide an ease of carrying out an oil bath management work involving removing fry residues accumulated in the oil bath 61. Also, an electrical wiring in the third embodiment is similarly implemented in the same way as those of the first and second embodiments. Moreover, other actions and effects of the third embodiment are similar to those of the first and second embodiments.

As set forth above, while the present invention has been described with reference to the first to third embodiments, the present invention is not limited thereto and a variety of modifications accompanying the spirit of the present invention may be possible. For example, in the first to third embodiments set forth above, while the present invention has been described in conjunction with a structure in which frying oil in the oil bath is directly heated using the heater pipe, it may be structured such that the heating means is provided outside the oil bath. Also, a variety of other elevating means than those of the embodiments set forth above may be applied as the elevating means of the electrode unit. Further, in the first to third embodiments set forth above, although the electric field shielding layer is formed over the entire inner surface area of the oil bath, the electric field shielding layer may be formed at a circumference of a region sandwiched between the electrode unit and the earth plate. Further, while the electric field shielding layer and the insulation covering are formed of fluorine resin, it may be possible for synthetic resin or ceramic material having other insulation properties to be applied.

The entire content of a Japanese Application No. P2000-340301 with a filing date of Nov. 8, 2000 is herein incorporated by reference.

Although the invention has been described above by reference to certain embodiments of the invention, the invention is not limited to the embodiments described above will occur to these skilled in the art, in light of the teachings. The scope of the invention is defined with reference to the following claims.

### INDUSTRIAL APPLICABILITY

As apparent from the foregoing description, according to the first aspect of the frier of the present invention, since the frying area between the electrode unit and the earth plate is surrounded by the electric field shielding layer, the high-voltage weak current resulting from the high voltage being applied to the electrode unit flows through the earth plate in a reliable manner, resulting in an action to increase the strength of the electric field at the frying area. As a result, since the high-voltage weak current passes through frying oil with the electric field being applied thereto, there are effects for restricting frying oil in the oil bath from being oxidized or from being deteriorated. Also, since frying oil and fried pieces such as food material prevailing in the fry area are exposed to the weak current, germs such as bacteria can be perished, with a resultant effect of having improved anti-virus properties and improved anti-spoiling properties.

Further, according to a third aspect of the frier of the present invention, aside from the effect of the first aspect, in a case where food pieces to be fried bear and float, since the food pieces to be fried can be reliably kept in contact with the earth plate to allow the high-voltage weak current to reliably pass through the food pieces to be fried, there is an advantageous action wherein moisture and nutrient component is prevented from being dissolved from food pieces to be fried to cause taste to be trapped and the food pieces to be fried are prevented from absorbing a large amount of oil to provide a sense of eating food fried crisp.

Further, according to a fourth aspect of the frier of the present invention, aside from the effect of the first aspect, it is possible to efficiently heat frying oil.

Furthermore, according to a fifth aspect of the frier of the present invention, aside from the effect of the first aspect, the high voltage electric current flowing from the electrode unit to the earth plate is enabled to include the weak current. For this reason, it becomes possible for the high-voltage weak current to afford a favorable effect on frying oil and food pieces to be fried.

Moreover, according to a sixth aspect of the frier of the present invention, aside from the effect of the first aspect, efficient convection of frying oil in the oil bath can be effectuated, resulting in an effect to provide an ease of setting a uniform frying oil temperature.

Additionally, according to a seventh aspect of the frier of the present invention, aside from the effect of the first aspect, food pieces to be fried in contact with the earth plate are brought into contact with the chains, contoured shapes of food pieces are absorbed by deflections of the chains to restrict food pieces, to be fried, from being deformed in shape.

Further, according to an eighth aspect of the frier of the present invention, aside from the effect of the first aspect, since the earth plate is formed of the net-like body, convention of frying oil can be easily performed and, in a case where the earth plate is disposed in the lower area of the electrode unit, it becomes possible to prevent frying residues from accumulating on the earth plate, resulting in an increase in a quality of food pieces to be fried.

Furthermore, according to a ninth aspect of the frier of the present invention, aside from the effect of the first aspect, since the electrode unit and the earth plate can be moved relative to one another, it becomes easy to locate food pieces to be fried in the frying area. For this reason, there is an effect of improving a frying efficiency of the firer.

1. A frier comprising an electrode unit applied with a high voltage and a grounded earth plate are disposed in an oil bath in mutually opposed relationship, and an electric field shielding layer composed of insulation material is disposed so as to surround a frying region between the electrode unit and the earth plate whereupon the electrode unit is applied with the high voltage to cause a high-voltage weak current to occur in the frying region.

2. The frier according to claim 1, wherein the electric field shielding layer is formed over and adheres to an entire inner side wall of the oil bath.

3. The frier according to claim 1, wherein a heater pipe is disposed in a bottom area of the oil bath such that the electrode unit is located above the heater pipe and the earth plate is located above the electrode unit.

4. The frier according to claim 1, wherein a heater pipe is disposed in a bottom area of the oil bath such that the earth plate is located above the heater pipe and the electrode unit is located above the earth plate.

5. The frier according to claim 1, wherein the electrode unit is formed by an electrode plate, made from conductive metal, which has an entire surface area covered with insulation material.

6. The frier according to claim 1, wherein the electrode unit is formed with an opening portion to allow convection of frying oil in the oil bath.

7. The frier according to claim 1, wherein the earth plate is formed by a frame body, made of conductive material, in which a plurality of chains, composed of conductive material, are spanned.

8. The frier according to claim 1, wherein the earth plate includes a net-like body composed of conductive material.

9. The frier according to claim 1, wherein the electrode unit and the earth plate are relatively moveable.
